(19) United States
(12) Patent Application Publication
(10) Pub. No.: US 2023/0388576 A1
(43) Pub. Date: Nov. 30, 2023

(54) ENGAGEMENT AND SYNCHRONIZATION USING RECEIVED AUDIO OR VISUAL CUES

(71) Applicant: Balanced Media Technology, LLC, McKinney, TX (US)

(72) Inventor: Corey Clark, Plano, TX (US)

(21) Appl. No.: 18/324,910

(22) Filed: May 26, 2023

Related U.S. Application Data
(60) Provisional application No. 63/365,408, filed on May 26, 2022.

(51) Int. Cl. H04N 21/43

(52) U.S. Cl. CPC H04N 21/43074

(57) ABSTRACT

Methods, apparatuses, and computer readable media for engagement and synchronization using received audio or visual cues. A method for content synchronization includes receiving, by an electronic device, video content for display on a display associated with the electronic device; identifying, by the electronic device, an indicator included in the video content; and in response to identifying the indicator, identifying, by the electronic device, additional content to include with the video content displayed on the display. The method further includes determining, by the electronic device, based on the video content, when to include the additional content with the video content and providing, by the electronic device, the additional content for display on the display with the video content based on the determination.

### CROSS-REFERENCE TO RELATED APPLICATION AND CLAIM OF PRIORITY

This application claims priority under 35 U.S.C. § 119(e) to U.S. Provisional Patent Application No. 63/365,408, filed on May 26, 2022. The content above-identified provisional patent application is hereby incorporated by reference in its entirety.

### TECHNICAL FIELD

This disclosure relates generally to electronic devices. More specifically, this disclosure relates to engagement and synchronization using received audio or visual cues.

### BACKGROUND

The use of electronic devices has greatly expanded largely due to their usability, convenience, computing power, and the like. One result of the recent technological development is that electronic devices are becoming more compact, while the number of functions performed by a given device is increasing. For example, some electronic devices support functions such as digital media playback, game play, electronic book (e-book) reading, digital image capture, calendar scheduling, wireless communications, Internet searching, to name a few. With the rise of mobile computing technology, a user can interact with the various functions and be provided with new information.

### SUMMARY

Embodiments of the present disclosure provide for engagement and synchronization using received audio or visual cues.

In one embodiment, a method for content synchronization is provided. The method includes receiving, by an electronic device, video content for display on a display associated with the electronic device; identifying, by the electronic device, an indicator included in the video content; and in response to identifying the indicator, identifying, by the electronic device, additional content to include with the video content displayed on the display. The method further includes determining, by the electronic device, based on the video content, when to include the additional content with the video content and providing, by the electronic device, the additional content for display on the display with the video content based on the determination.

In another embodiment, an electronic device is provided. The electronic device includes a communication interface configured to receive video content for display on a display associated with the electronic device and a processor operably coupled with the communication interface. The processor is configured to identify an indicator included in the video content; in response to identification of the indicator, identify additional content to include with the video content displayed on the display; determine, based on the video content, when to include the additional content with the video content; and provide the additional content for display on the display with the video content based on the determination.

In yet another embodiment, a non-transitory, computer-readable medium is provided. The non-transitory, computer-readable medium comprises program code that, when executed by a processor of an electronic device, causes the electronic device to receive video content for display on a display associated with the electronic device; identify an indicator included in the video content; in response to identifying the indicator, identify additional content to include with the video content displayed on the display; determine, based on the video content, when to include the additional content with the video content; and provide the additional content for display on the display with the video content based on the determination.

Other technical features may be readily apparent to one skilled in the art from the following figures, descriptions, and claims.

As used herein, the term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example communication system in accordance with an embodiment of this disclosure;

FIGS. 2 and 3 illustrate example electronic devices in accordance with an embodiment of this disclosure;

FIG. 4A illustrates an example timing diagram in accordance with an embodiment of this disclosure;

FIG. 4B illustrates an example method for engagement in accordance with an embodiment of this disclosure;

FIGS. 5A and 5B illustrate example methods for syncing content in a video in accordance with an embodiment of this disclosure; and

FIGS. 6A, 6B, and 6C illustrate example diagrams of an electronic device displaying content in accordance with an embodiment of this disclosure.

### DETAILED DESCRIPTION

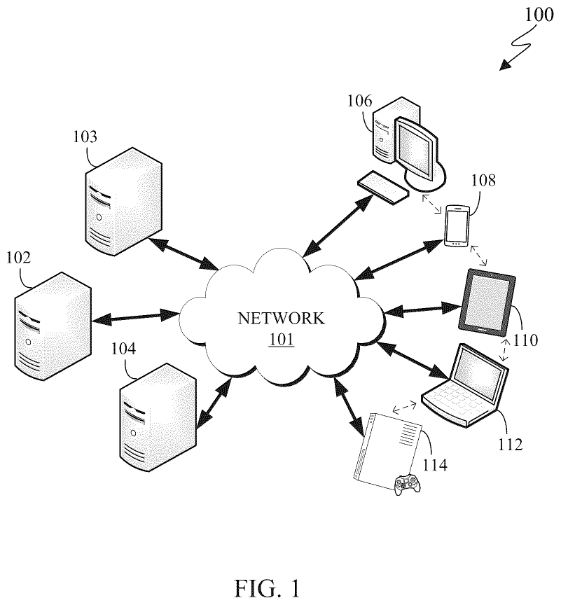

FIGS. 1 through 6C, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably-arranged system or device.

An electronic device, according to embodiments of the present disclosure can include a user equipment (UE) such as a mobile phone. The electronic device can also refer to any component such as mobile station, subscriber station, remote terminal, wireless terminal, receive point, vehicle, or user device. The electronic device could be a mobile telephone, a smartphone, a monitoring device, an alarm device, a fleet management device, an asset tracking device, an automobile, a desktop computer, an entertainment device, an infotainment device, a vending machine, an electricity meter, a water meter, a gas meter, a security device, a sensor device, an appliance, and the like. Additionally, the electronic device can include a personal computer (such as a laptop, a desktop), a workstation, a server, a television, an appliance, and the like. In certain embodiments, an electronic device can be a portable electronic device such as a portable communication device (such as a smartphone or mobile phone), a laptop, a tablet, an electronic book reader (such as an e-reader), a personal digital assistants (PDAs), a portable multimedia player (PMP), an MP3 player, a mobile medical device, a virtual reality headset, a portable game console, a camera, and a wearable device, among others. Additionally, the electronic device can be at least one of a part of a piece of furniture or building/structure, an electronic board, an electronic signature receiving device, a projector, or a measurement device. The electronic device is one or a combination of the above-listed devices. Additionally, the electronic device as disclosed herein is not limited to the above-listed devices and can include new electronic devices depending on the development of technology. It is noted that as used herein, the term “user” may denote a human or another device (such as an artificial intelligent electronic device) using the electronic device.

Embodiments of the present disclosure take into consideration that content developers strive to provide new and unique methods for engaging with a user of an electronic device. For example, a successful content develop can provide useful content and information to the user at times when the user may want that information. That is, if useful information is provided at an inconvenience time for that user or at a time when that user is not interested in that content, then the provided content may be ignored by that user. For example, if a user is viewing a video, and content related to another scene in the video is provided to the user (such as by a pop-up notification, an overlay, or the like), the user may ignore the information as that information is not relevant to the current scene. However, if a user is viewing a video (including a pre-recorded event or a live stream) and a certain event occurs, then the user may find certain information related to that event useful while the event is occurring. Similarly, if the user is playing a video game, simply displaying the information at a certain time instance in the game may not be useful to the user if the user is not at a certain location in the game. Moreover, if the user is at the certain location in the game where the information could be useful, but a certain object is not being displayed, the information may still not be useful to the user.

Embodiments of the present disclosure provide systems and methods for synchronizing when information is provided to a user. For example, if a video is live of a live event that can also be viewed at a later time, the embodiments of the present disclosure describe how to provide the information at a time when relevant to the user.

Embodiments of the present disclosure also provide systems and methods for including an indicator in a video stream. The video stream can be accessed on a video based platform (or streaming service) such as YOUTUBE, TWITCH, FACEBOOK, or the like. As disclosed herein, an indicator can be included at a certain location in the video that when detected on a viewing device associated with user can cause an overlay or popup to display certain information that the view may find useful.

Embodiments of the present disclosure also provide systems and methods for providing a reward system for engaging with a user of an electronic device. For example, content developers can provide rewards (physical or digital) to a user based on certain actions a user performs. For example, a content developer can provide a reward to a user that user was at a certain location or observed certain content.

Embodiments of the present disclosure also provide systems and methods for providing physical feedback to a user. In a VR or an augmented reality (AR) environment, video stimuli can be a provided via a head mounted display (HMD) and audio stimuli can be provided by headphones or speakers. Embodiments of the present disclosure describe using haptic feedback on a controller that a user is holding to provide yet another element of immersion for the user (in addition to the video and/or auditory stimuli). If a user is playing a video game that is displayed, a user interface device can provide haptic feedback to the user. For example, an electronic device (such as an egg, an action figure, a user interface controller (such as a mouse or game controller), or the like) with an input device (such as a microphone, light sensor, or the like) can vibrate in response to receiving an input such as when a certain sound is received or a certain light color, wavelength, pattern of flashing lights, or the like is detected. For instance, the controller can vibrate in response to the controller detecting a certain light-based signal (such as a predefined pulsed pattern of light, a certain color that is pulsed at a certain frequency). For another instance, when the controller detects a certain sound that is output from a speaker while the user is playing a video game, the controller can vibrate. The vibrations can occur at select situations in response to detecting particular sounds, thereby further immersing the user in the game play (in addition to the video and audio stimuli).

FIG. 1 illustrates an example networked system 100 in which various embodiments of the present disclosure may be implemented. The embodiment of the networked system 100 shown in FIG. 1 is for illustration only. Other embodiments of the networked system 100 could be used without departing from the scope of this disclosure.

As shown in FIG. 1, the system 100 includes a network 101, which facilitates communication between various components in the system 100. For example, the network 101 may communicate Internet Protocol (IP) packets or other information between network addresses. The network 101 may include one or more local area networks (LANs); metropolitan area networks (MANs); wide area networks (WANs); a virtual private network (VPN); all or a portion of a global network, such as the Internet; or any other communication system or systems at one or more locations.

The network 101 facilitates communications among various servers 102-104 and various client devices 106-114. Each of the servers 102-104 may be any suitable electronic computing or processing device(s) that can provide computing services including software for one or more client devices 106-114. Each of the servers 102-104 could, for example, include one or more processing devices, one or more memories storing instructions and data, and one or more network interfaces facilitating communication over the network 101. For example, as discussed in greater detail below, the server 102 may provide or manage providing an indication in media content for synchronizing content, providing user feedback (such as haptic feedback), and the like using one or more of the client devices 106-114. For another example, the server 102 may provide or manage a reward system based on received notifications from one or more of the client devices 106-114. The reward system can be associated with an account associated with a user and linked to one or more of the client devices 106-114.

Each client device 106-114 represents any suitable electronic computing or processing device that interacts with at least one server or other computing device(s) over the network 101. In this example, the client devices 106-114 include a desktop computer 106, a mobile telephone or smartphone 108, a tablet computer 110, a laptop computer 112, a video game console 114; a set-top box and/or television, etc. However, any other or additional client devices could be used in the networked system 100. For example, any Internet or network connectable device or Internet of Things (IoT) device (e.g., Smart TVs, refrigerators, Raspberry PIs, etc.) could be used for one of the client devices 106-114 in system 100. For another example, peripheral devices (such as a game controller, a mouse, a keyboard, or the like) can also be used as one of the client devices 106-114 in system 100. As discussed below, in various embodiments, client devices 106-114 participate, under the coordination of server 102, to process various tasks such as transmitting and receiving signals for user engagement purposes. For example, as discussed herein, the client devices 106-114 may be run various video games or interactive applications that include the ability to display content in a synced manner based on an event in the video game, perform feedback to the user (such as haptic feedback), and the like. Additionally, in various embodiments, any of the client devices 106-114 may generate, send, and/or analyze signals, such as sound signals, radio frequency (RF) signals, light signals (such as various colors, varying wavelengths, various frequency of light pulses, and the like), other types of electromagnetic signals or waves, or the like. In some embodiments, individual client devices 106-114 can communicate with each other or a server directly or indirectly using, for example, a peer to peer, ad hoc, and/or mesh-based networks with or without a centralized server. In certain embodiments individual client devices 106-114 can communicate with each other or a server using Wi-Fi, near field communication (NFC), BLUETOOTH, infrared, sound, or any other RF signals.

Although FIG. 1 illustrates one example of a networked system 100, various changes may be made to FIG. 1. For example, the system 100 could include any number of each component in any suitable arrangement and each of servers 102-104 and client devices 106-114 may be representative of any number of servers and/or client devices that are part of system 100. In general, computing and communication systems come in a wide variety of configurations, and FIG. 1 does not limit the scope of this disclosure to any particular configuration. While FIG. 1 illustrates one operational environment in which various features disclosed in this patent document can be used, these features could be used in any other suitable system.

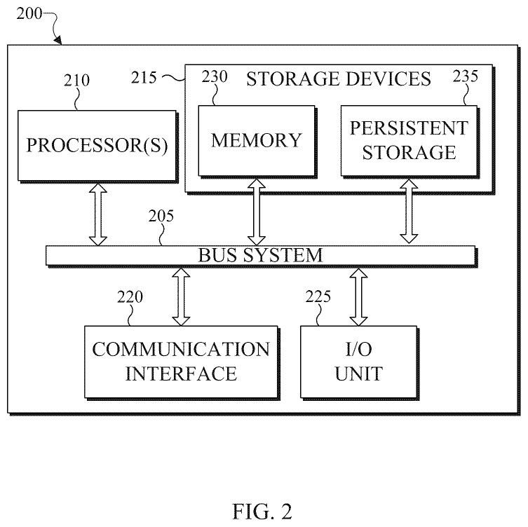

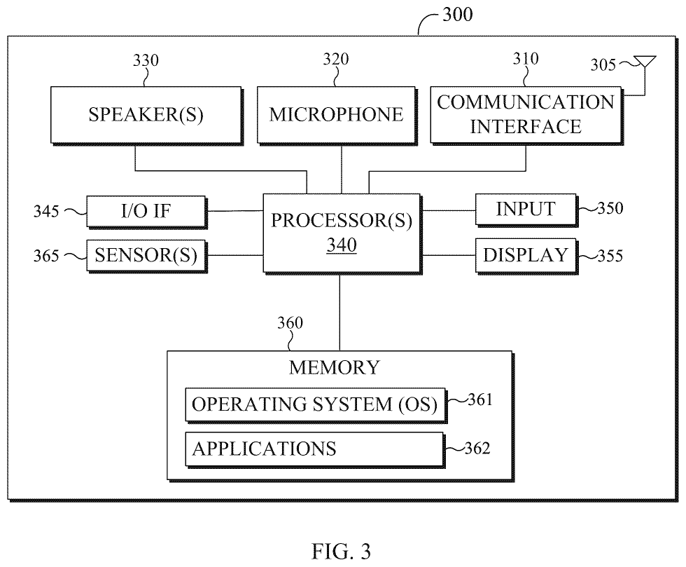

FIGS. 2 and 3 illustrate example computing devices in a networked system according to various embodiments of the present disclosure. In particular, FIG. 2 illustrates an example server 200, and FIG. 3 illustrates an example client device 300. In this illustrative example, the server 200 represents any one of the servers 102-104 in FIG. 1, and the electronic device 300 could represent one or more of the client devices 106-114 in FIG. 1.

As shown in FIG. 2, the server 200 includes a bus system 205, which supports communication between processor(s) 210, storage devices 215, communication interface 220, and input/output (I/O) unit 225. The processor(s) 210 executes instructions that may be loaded into a memory 230. The processor(s) 210 may include any suitable number(s) and type(s) of processors or other devices in any suitable arrangement. Example types of processor(s) 210 include microprocessors, microcontrollers, digital signal processors, field programmable gate arrays, application specific integrated circuits, and discrete circuitry.

The memory 230 and a persistent storage 235 are examples of storage devices 215, which represent any structure(s) capable of storing and facilitating retrieval of information (such as data, program code, and/or other suitable information on a temporary or permanent basis). The memory 230 may represent a random access memory or any other suitable volatile or non-volatile storage device(s). The persistent storage 235 may contain one or more components or devices supporting longer-term storage of data, such as a read-only memory, hard drive, Flash memory, or optical disc. For example, persistent storage 235 may store one or more databases of data, client applications, reward systems (including accrued rewards), video data, text data, audio data, and the like for distribution over the network 101.

The communication interface 220 supports communications with other systems or devices. For example, the communication interface 220 could include a network interface card or a wireless transceiver facilitating communications over the network 101. The communication interface 220 may support communications through any suitable physical or wireless communication link(s).

The I/O unit 225 allows for input and output of data. For example, the I/O unit 225 may provide a connection for user input through a keyboard, mouse, keypad, touchscreen, or other suitable input device. The I/O unit 225 may also send output to a display, printer, or other suitable output device.

Although FIG. 2 illustrates one example of a server 200, various changes may be made to FIG. 2. For example, various components in FIG. 2 could be combined, further subdivided, or omitted and additional components could be added according to particular needs. As a particular example, while depicted as one system, the server 200 may include multiple server systems that may be remotely located. In another example, different server systems may provide some or all of the processing, storage, and/or communication resources for synchronization and engagement purposes in accordance with various embodiments of the present disclosure.

FIG. 3 illustrates an example client device 300 according to embodiments of the present disclosure. The embodiment of the electronic device 300 illustrated in FIG. 3 is for illustration only, and one or more of the client devices 106-114 of FIG. 1 could have the same or similar configuration. However, client devices come in a wide variety of configurations, and FIG. 3 does not limit the scope of this disclosure to any particular implementation of an electronic device.

As shown in FIG. 3, the electronic device 300 includes an antenna 305, a communication interface 310, a microphone 320, and a speaker 330. The electronic device 300 also includes a processor 340, an I/O interface 345, an input 350, a display 355, a memory 360, and a sensor(s) 365. The memory 360 includes an operating system (OS) 361 and one or more applications 362.

The communication interface 310 can be similar to the communication interface 220 of FIG. 2. The communication interface 310 supports communications with other systems or devices. For example, the communication interface 310 could include a network interface card or a wireless transceiver facilitating communications over the network 101. The communication interface 310 may support communications through any suitable physical or wireless communication link(s). For embodiments utilizing wireless communication, the communication interface 310, can include an RF transceiver, a BLUETOOTH transceiver, a WI-FI transceiver, a ZIGBEE transceiver, an infrared transceiver, a radio frequency identifier (RFID) tag (e.g., active or passive) and various other transceivers for receiving and/or transmitting wireless communication signals. The communication interface 310 can receive (via the antenna 305) an incoming RF signal using a variety of wireless communication protocols, (such as BLUETOOTH, Wi-Fi, cellular, LTE communication protocols, or the like). The signal can be transmitted from an access point (such as a base station, WI-FI router, or BLUETOOTH device) or other device of the network 101 (such as a WI-FI, BLUETOOTH, cellular, 5G, LTE, LTE-A, WiMAX, or any other type of wireless network). The communication interface 310 can also receive, from the processor, data to be transmitted via an RF signal to an access point or another device of the network 101.

The microphone 320 according to an embodiment may receive a sound and convert the sound into an electrical signal. The received sound can be in the audible spectrum, the non-audible spectrum, or both.

The speaker 330 according to an embodiment may output electrical signal as a sound. For example, the speaker 330 may output sound signals to the outside of the electronic device 300. The speaker 330 may be used for general purposes, such as playing audio content. In certain embodiments, the speaker 330 can output sound in both the audible and non-audible spectrum.

The processor 340 can include one or more processors or other processing devices. The processor 340 can execute instructions that are stored in the memory 360, such as the OS 361 in order to control the overall operation of the electronic device 300. The processor 340 can include any suitable number(s) and type(s) of processors or other devices in any suitable arrangement. For example, in certain embodiments, the processor 340 includes at least one microprocessor or microcontroller. Example types of processor 340 include microprocessors, microcontrollers, digital signal processors, field programmable gate arrays, application specific integrated circuits, and discrete circuitry.

The processor 340 is also capable of executing other processes and programs resident in the memory 360, such as operations that receive and store data. The processor 340 can move data into or out of the memory 360 as required by an executing process. In certain embodiments, the processor 340 is configured to execute one or more applications 362 based on the OS 361 or in response to signals received from external source(s) or an operator. Example, applications 362 can include video games, videos, location identification applications (such as global positioning system (GPS)), VR or AR application, a camera application (for still images and videos), a video phone call application, an email client, a social media client, a SMS messaging client, a virtual assistant, and the like.

The processor 340 is also coupled to the I/O interface 345 that provides the electronic device 300 with the ability to connect to other devices, such as client devices 106-114. The I/O interface 345 is the communication path between these accessories and the processor 340.

The processor 340 is also coupled to the input 350 and the display 355. The operator of the electronic device 300 can use the input 350 to enter data or inputs into the electronic device 300. The input 350 can be a keyboard, a touchscreen, a mouse, a track ball, a controller (such as a video game controller), a joystick, a voice input, a sound or other device capable of acting as a user interface to allow a user to interact with the electronic device 300. For example, the input 350 can include voice recognition processing, thereby allowing a user to input a voice command. In another example, the input 350 can include a touch panel, a (digital) pen sensor, a key, or an ultrasonic input device. The touch panel can recognize, for example, a touch input in at least one scheme, such as a capacitive scheme, a pressure sensitive scheme, an infrared scheme, or an ultrasonic scheme. The input 350 can be associated with the sensor(s) 365 and/or a camera by providing additional input to the processor 340. In certain embodiments, the sensor 365 includes one or more inertial measurement units (IMUs) (such as accelerometers, gyroscope, and magnetometer), motion sensors, optical sensors, cameras, pressure sensors, heart rate sensors, altimeter, and the like. The input 350 can also include a control circuit. In the capacitive scheme, the input 350 can recognize touch or proximity.

The display 355 can be a liquid crystal display (LCD), light-emitting diode (LED) display, organic LED (OLED), active matrix OLED (AMOLED), or other display capable of rendering text and/or graphics, such as from websites, videos, games, images, and the like. The display 355 can be sized to fit within an HMD. The display 355 can be a singular display screen or multiple display screens capable of creating a stereoscopic display. In certain embodiments, the display 355 is a heads-up display (HUD). The display 355 can display 3D objects, such as an animated 3D object.

The memory 360 is coupled to the processor 340. Part of the memory 360 could include a RAM, and another part of the memory 360 could include a Flash memory or other ROM. The memory 360 can include persistent storage (not shown) that represents any structure(s) capable of storing and facilitating retrieval of information (such as data, program code, and/or other suitable information). The memory 360 can contain one or more components or devices supporting longer-term storage of data, such as a read only memory, hard drive, Flash memory, or optical disc. The memory 360 also can contain media content. The media content can include various types of media such as images, videos, three-dimensional content, VR content, AR content, animated and static 3D objects, and the like.

The electronic device 300 further includes one or more sensors 365 that can meter a physical quantity or detect an activation state of the electronic device 300 and convert metered or detected information into an electrical signal. For example, the sensor 365 can include one or more buttons for touch input, a camera, a gesture sensor, an IMU sensors (such as a gyroscope or gyro sensor and an accelerometer), an eye tracking sensor, an air pressure sensor, a magnetic sensor or magnetometer, a grip sensor, a proximity sensor, a color sensor, a bio-physical sensor, a temperature/humidity sensor, an illumination sensor, an Ultraviolet (UV) sensor, an Electromyography (EMG) sensor, an Electroencephalogram (EEG) sensor, an Electrocardiogram (ECG) sensor, an IR sensor, an ultrasound sensor, an iris sensor, a fingerprint sensor, a color sensor (such as a Red Green Blue (RGB) sensor/camera), a depth sensor, a D-RGB sensor (depth Red Green Blue sensor/camera), a location sensor (such as GPS), an RFID receiver, and the like. The sensor 365 can further include control circuits for controlling any of the sensors included therein.

As discussed in greater detail below, one or more of these sensor(s) 365 can include haptic sensor. The haptic sensor converts an electrical signal into a mechanical stimulus (e.g., a vibration or a movement) or electrical stimulus which may be recognized by a user via his tactile sensation or kinesthetic sensation. According to an embodiment, the haptic sensor may include, for example, a motor, a piezoelectric element, an electric stimulator, or the like.

Although FIGS. 2 and 3 illustrate examples of electronic devices, various changes can be made to FIGS. 2 and 3. For example, various components in FIGS. 2 and 3 could be combined, further subdivided, or omitted and additional components could be added according to particular needs. As a particular example, the processor 340 could be divided into multiple processors, such as one or more central processing units (CPUs) and one or more graphics processing units (GPUs). In addition, as with computing and communication, electronic devices and servers can come in a wide variety of configurations, and FIGS. 2 and 3 do not limit this disclosure to any particular electronic device or server.

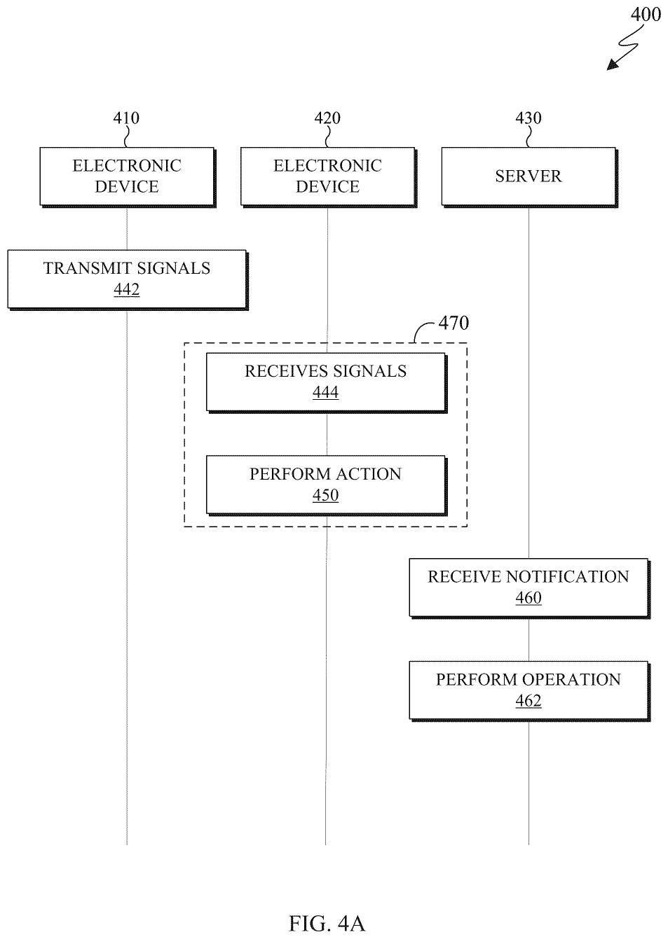

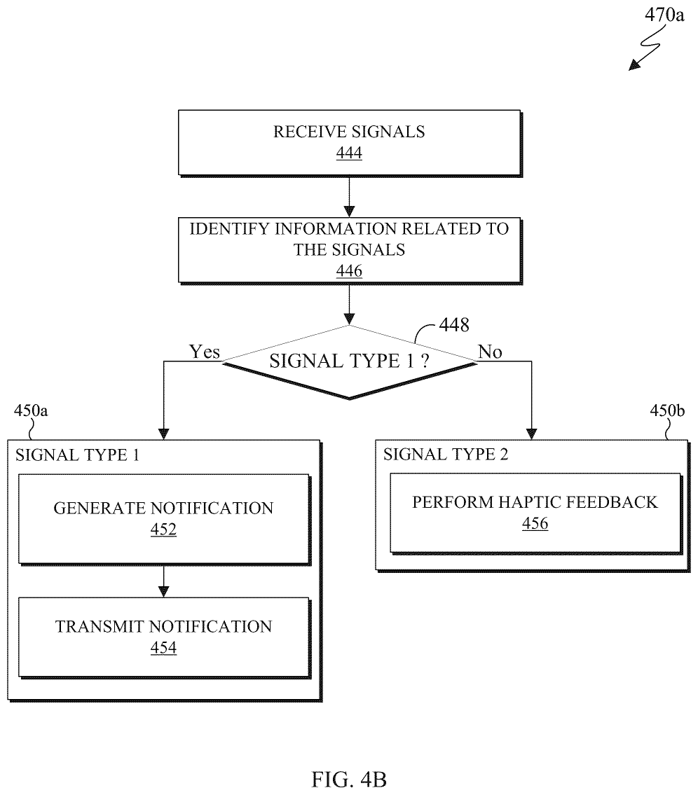

Embodiments of the present disclosure describe various methods for engaging a user, such as by providing proof of experience including providing haptic feedback, registering the user's attendance, and rewards for upon detecting certain sounds or signals. For example, the proof of experience can provide a user credit, which can an enhanced user experience by trading in accumulated credits from one or more previous engagement for physical and digital objects. The credit can be provided to a user for viewing certain content, being at a certain location, and the like. For another example, the proof of experience can also provide haptic feedback to the user. This is described in the following examples and embodiments, such as those of FIGS. 4A and 4B.

FIG. 4A illustrates an example timing diagram 400 in accordance with an embodiment of this disclosure. FIG. 4B illustrates an example method 470a for engagement in accordance with an embodiment of this disclosure. The steps of the method 470a of FIG. 4B can be performed by any of the client devices 106-114 of FIG. 1, such as the electronic device 300 of FIG. 3. The timing diagram 400 and the method 470a are for illustration only and other embodiments can be used without departing from the scope of the present disclosure.

The timing diagram 400 of FIG. 4A illustrates an electronic device 410, an electronic device 420, and a server 430. The electronic device 410 and the electronic device 420 can be similar to any of the client devices 106-114 of FIG. 1 and include internal components similar to the electronic device 300 of FIG. 3. Similarly, the server 430 can be similar to any of the servers 102-104 of FIG. 1 and include internal components similar to the server 200 of FIG. 2. In certain embodiments, the server 430 is omitted from the timing diagram 400.

In certain embodiments, the electronic device 410 is a portable device while the electronic device 420 is stationary. In this example, the server 430 can provide a reward an account associated with the user of the electronic device 410 such as when the electronic device 410 is moved within a predefined distance from the electronic device 420.

In this embodiment, the electronic device 410, which is a portable device, transmits signals (step 442). For example, the electronic device 410 can move with the user. For instance, the electronic device 410 can be carried by the user (such as in the hands of the user), located in a pocket of clothing worn by the user, affixed to clothing worn by the user, located in a bag carried by the user, or the like. The signals transmitted by the electronic device 410 can be audible or inaudible sound waves generated by a speaker, such as the speaker 330 of FIG. 3. The signals transmitted by the electronic device 410 can be RF signals, infrared (IR) signals, sound signals, light signals, or the like. The signals can be continuously transmitted or transmitted based on a pattern or a detected event. In some embodiments, the electronic device 410 may include an RFID tag to communicate such signals actively or passively. For example, an RFID receiver at a location may detect presence of the electronic device 410 in proximity of the location to receive the signals, which may not necessarily be actively transmitted by the electronic device 410.

In step 444, the electronic device 420 receives the signals transmitted by the electronic device 410. In this example, the electronic device 420 is stationary and located at a particular location. For example, if the electronic device 420 is located at a concert or conference and receives the signals transmitted from the electronic device 410, then it can be determined that the electronic device 410 is at the same location as the electronic device 420.

In step 450, the electronic device 420 performs an action. In this example, the action could be generating and sending a notification to the server 430. The notification can be transmitted via the network 101 to the server 430. The notification can notify the server 430 that the electronic device 410 is located at the same or similar location as the electronic device 420.

In step 460, the server 430 receives the notification that was transmitted by the electronic device 420. In step 462, the server 430 performs an operation. For example, the server 430 can determine the location of the electronic device 410, based on the known location of the electronic device 420. The server 430 can then look up a reward account associated with the user of the electronic device 410. When there is a reward account associated with the user of the electronic device 410, the server provides a reward to the reward account. In certain embodiments, the reward can have monetary value. In certain embodiments, the reward can be linked to the profile of the user. The profile of the user can indicate how many locations that the user has visited. In certain embodiments, the reward can be represented as points. For example, the points can be spent in a game to upgrade a character, improve an avatar representing the user, obtain digital content, and the like.

In certain embodiments, the electronic device 410 is stationary and the electronic device 420 can be stationary or portable. In this example, the server 430 can provide a reward to an account associated with the user of the electronic device 420. It is noted that this example is different than the above embodiment, which previously describes (i) the electronic device 410 being portable while the electronic device 420 is stationary and (ii) the server 430 providing the reward to the electronic device 410.

In this embodiment, the electronic device 410 is stationary and emits sounds through a speaker, such as the speaker 330 of FIG. 3 (step 442). For example, the electronic device 410 can be associated with a speaker (such as the speaker 330 of FIG. 3) at an event such as a concert setting, a commercial setting, an industrial setting, a residential setting, or the like. The sound can be audible (such as instrumental or verbal sounds), inaudible, or both. The electronic device 410 can also transmit RF signals in addition to or instead of the sound waves.

As described above, the electronic device 420 can be stationary or portable. For example, the electronic device 420 can be carried by the user (such as in the hands of the user), located in a pocket of clothing worn by the user, affixed to clothing worn by the user, located in a bag carried by the user, or the like. For another example, the electronic device 420 can be stationary such as a listening device that remains at a certain location listening for certain sounds. For yet another example, the electronic device 420 can be used for interacting with another electronic device such as a game controller or mouse.

In step 444, the electronic device 420 receives the signals transmitted by the electronic device 410. For example, the electronic device 420 can include a microphone similar to the microphone 320 of FIG. 3 for converting sound into electrical signals. For another example, the electronic device 420 can include a receiver (or transceiver), similar to the communication interface 310 of FIG. 3 for receiving the RF signals.

In step 450, the electronic device 420 performs an action. For example, based on a type of signal or indicators associated with the signal the electronic device 420 can perform various actions. In one example, the electronic device 420 can send a notification to the server 430. The notification can inform the server that the electronic device 420 received certain signals from another device, identified as the electronic device 410. For instance, the notification can inform the server 430 that the electronic device 420 is at a location similar to the electronic device 410 (since it was able to receive signals transmitted by the electronic device 410). The notification can also inform the server 430 that a user of the electronic device 420 is listening to certain audio. In another example, the electronic device can provide haptic feedback to the user upon receiving the signals. For instance, the electronic device 420 can be a game controller (such as a mouse) that vibrates upon detecting a certain sound while the user is playing a video game (emitted from the electronic device 410). In another example, the action may be related to unlocking a property of or associated the electronic device 420. For example, the electronic device 420 may be an egg or action figure associated with a game or video. Based on reception of a certain number of chirps or other sounds received or detected (e.g., as evidence that the user with the electronic device 420 was present at a location for a certain amount of time or consumed digital content for a certain amount of time), the egg may hatch, or abilities associated with the action figure may be unlocked or improve.

In some examples, the electronic device 420 may be associated with a digital good such as a non-fungible token (NFT). In such embodiments, the electronic device 420 may be a personal electronic device of an owner of the digital good and may detect that the user of electronic device 420 was to receive a reward (e.g., for content consumption or location attendance as discussed before). As a result, the server 430 may determine to improve or modify a value, appearance, or other quality of the digital good as the reward. In some embodiments, the digital good may be an action figure, character, or object in a game or video. In some examples, improving or modifying the quality of the digital good may involve modifying the appearance or abilities of the action figure in the game or video.

In other examples of actions performed, the action may be associated with either or both of a physical and digital representation. For example, in addition to the receipt or modification of digital goods, a physical object such as a badge or game object may have modified physical properties such as light or color and are associated with a digital good that has corresponding modified digital properties.

The block 470, which includes the step 444 and the step 450, is described in greater detail in the method 470a of FIG. 4B.

In step 460, the server 430 receives a notification that was transmitted by the electronic device 420.

In step 462, the server 430 performs an operation. For example, the server 430 can determine the location of the electronic device 420, based on the known location of the electronic device 410. The server 430 can look up a reward account associated with the user of the electronic device 420. When there is a reward account associated with the user of the electronic device 420, the server 430 provides a reward to the reward account. for example, the reward can be given in exchange for the user being at a similar location as the electronic device 410. In certain embodiments, the reward can have monetary value. In certain embodiments, the reward can be linked to the profile of the user. For example, the profile of the user can indicate how many locations that the user has visited. In certain embodiments, the reward can be represented as points. For example, the points can be spent in a game to upgrade a character, improve an avatar representing the user, obtain digital content, obtain or modify a digital good, and the like.

It is noted that the steps 460 and 462 can be omitted if the action performed by the electronic device 420 in step 450 is not sending a notification. For another example, the electronic device 420 can store information regarding the event locally for a period of time. The information regarding the event can be transmitted in response to another event occurring, such as when the electronic device is scanned at the later point in time.

The method 470a of FIG. 4B describes the block 470 of FIG. 4A in greater detail. In step 444, the electronic device 420 receives signals. The signals can be transmitted from the electronic device 410. The signals can be audible, inaudible, RF, or the like.

In step 446, the electronic device 420 identifies information related to the received signals. The information can be identified based on the signal itself, sensors associated with the electronic device 420 (such as the sensor 365 of FIG. 3), or the like. For example, the related information can be identified based on the signal type (being audio, RF, or a certain RF signal). For instance, a BLUETOOTH signal can indicate something different than an audible sound signal. Similarly, the signal itself could represent the related information. For another example, the related information can be identified based on whether the sensors of the electronic device 420 detect a physical measurement such as a detection of light, dark, pressure, altitude, motion, or the like. For instance, the related information could indicate whether the electronic device 420 is portable as compared to stationary based on motion is detected at a time near when the signals are received. For yet another example, the related information can be based on a type of device of the electronic device 420. For instance, the related information can indicate that the electronic device 420 is an interface item such as a mouse, keyboard, game controller, or the like.

In step 448, the electronic device 420 determines a signal type. The signal can represent a proof of experience. The proof of experience can cause haptic feedback or physical motion of a peripheral device. The proof of experience can also provide a reward to a user that can be redeemed at a later date and/or location. The determination of the signal type can be based on the related information and the received signals. For example, the determination of the signal type can be based on whether the signal is BLUETOOTH as compared to an audio based sound. For another example, the determination of the signal type can be based on whether the electronic device 420 is moving or stationary. For another example, the determination of the signal type can be based on a device category of the electronic device 420.

Upon a determination (in step 448) that the signal is categorized as a first signal type, then the electronic device 420 performs steps 450a. For example, the steps 450a can be performed based upon a determination of the location of the electronic device 420 (such as at a concert venue or location where the electronic device 410 is located) as indicated by one or more sensors. For instance, the location can be identified via a location type sensor (such as GPS) of the electronic device 420. For another example, the steps 450a can be performed based on the content associated with the signal. For instance, the signal itself can specify that it is a first type of signal.

In step 452, the electronic device 420 generates a notification. The notification can indicate the presence of the electronic device 410. For example, the notification can indicate that the electronic device 410 is within a predefined distance of the electronic device 420. The notification can also indicate information associated with the content of the received signals. For example, the notification can indicate that the user of the electronic device 420 is listening to certain content (based on the received sound signals from step 444). For instance, when the user of the electronic device 420 and the electronic device 420 are co-located (such as when the electronic device 420 is worn by the user) the electronic device 420 will obtain the same sound signals via a microphone (such as the microphone 320 of FIG. 3) as heard by the user. As such, the generated notification can specify what content user of electronic device 420 heard. Based on that indication, the server 430 can provide a reward to a reward account associated with the user of the electronic device 420.

In step 454, the electronic device transmits the notification to the server 430. Based on the indication included in the notification, the server 430 provides a certain reward to a reward account associated with the user of the electronic device 420.

Upon a determination (in step 448) that the signal is categorized as a second signal type, then the electronic device 420 performs step 450b. For example, the steps 450b can be performed based on the content associated with the signal. For instance, the signal itself can specify that it is a second type of signal. For another example, the steps 450b can be performed when the electronic device is categorized as a certain device type such as a user interface controller similar to a mouse.

In step 456, the electronic device 420 performs a haptic feedback based on the received signal. In certain embodiments, the electronic device 420 can perform different vibration patterns based on different signals that are received. That is, multiple signals can be categorized as a second signal type, where each signal indicates that the electronic device 420 is to perform a different vibrational pattern.

In these embodiments, the user of the electronic device 410/420 is given rewards and/or attendance credit for viewing content or attending events passively, without needing to provide information to or register with the event or content provided. Additionally, the provider or promoter of the event or content is better able to identify attendees and interest in the event and engage with the attendees without needing to have the attendees register directly with the provider or promoter of the event or content.

Although FIG. 4A illustrates the timing diagram 400 and FIG. 4B illustrates the method 470a various changes may be made to FIGS. 4A and 4B. For example, while the method 470a is shown as a series of steps, various steps could overlap, occur in parallel, occur in a different order, or occur multiple times. In another example, steps may be omitted or replaced by other steps. For example, steps of the method 470a can be executed in a different order.

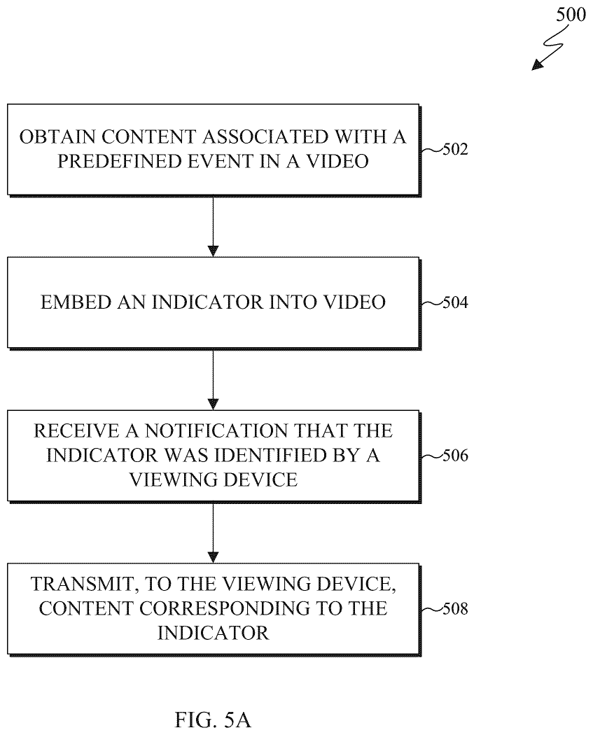

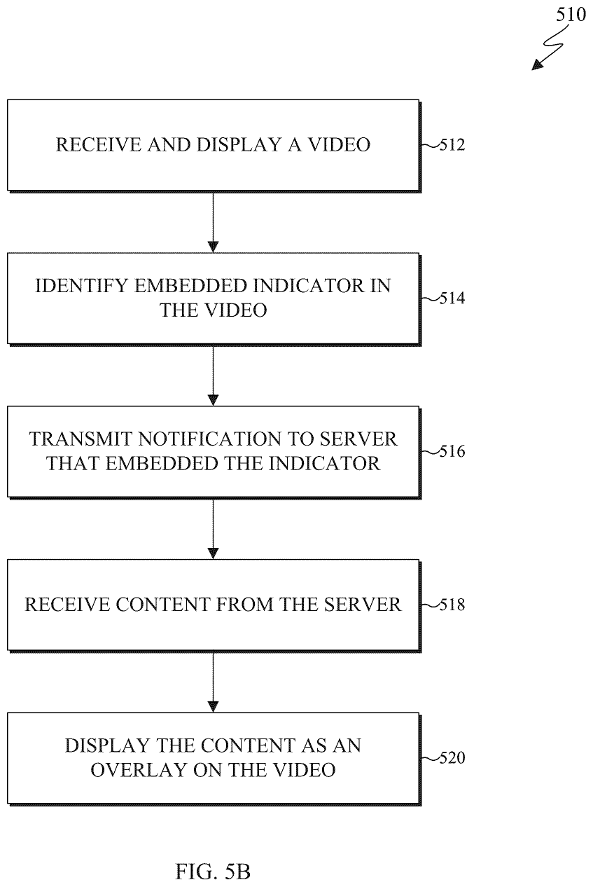

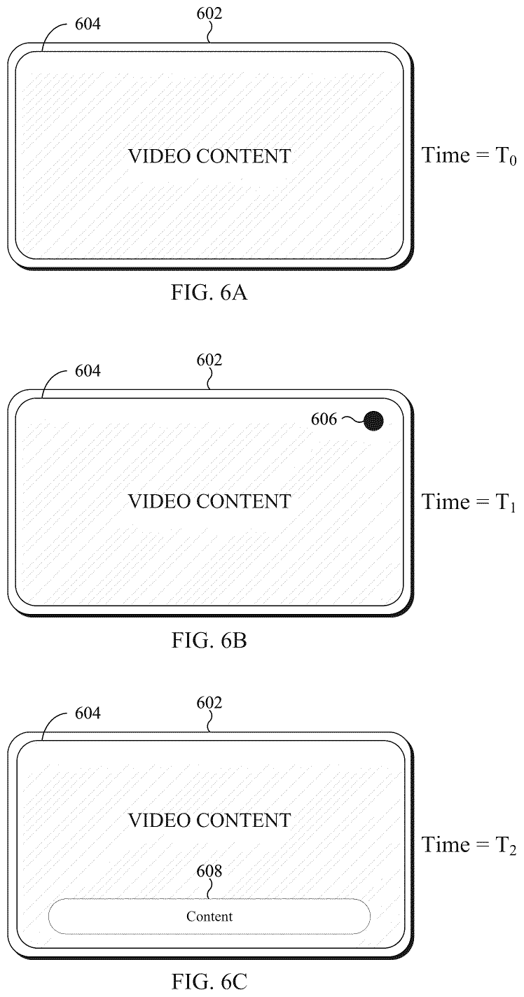

Embodiments of the present disclosure describe various methods for syncing content in a video. This is described in the following examples and embodiments, such as those of FIGS. 5A-6C.

FIGS. 5A and 5B illustrate example methods 500 and 510, respectively, for syncing content in a video in accordance with an embodiment of this disclosure. In particular, the method 500 of FIG. 5A describes a method performed by a server for syncing content in a video in accordance with an embodiment of this disclosure. The method 510 of FIG. 5B describes a method performed by a user device for syncing content in a video in accordance with an embodiment of this disclosure. FIGS. 6A, 6B, and 6C illustrate example diagrams of an electronic device 602 displaying content in accordance with an embodiment of this disclosure. The steps of the method 500 of FIG. 5A can be performed by any of the servers 102-104 of FIG. 1, such as the server 200 of FIG. 2. The steps of the method 510 of FIG. 5B can be performed by any of the client devices 106-114 of FIG. 1, such as the electronic device 300 of FIG. 3. The methods 500 and 510 and the diagrams of FIGS. 6A-6C are for illustration only and other embodiments can be used without departing from the scope of the present disclosure.

The method 500 of FIG. 5A describes a server including an indicator in a video stream for synchronizing content. In step 502, the server 300 obtains content associated with a predefined event in a video. The video can be live streamed or pre-recorded. The video can be for streaming onto an electronic device (such as any client devices 106-114 of FIG. 1, and the electronic device 300 of FIG. 3) of an end user. In certain embodiments, the video can be VR or AR. The content can be generated by a third party unaffiliated with the creator of the video itself.

In step 504, the server 200 embeds an indicator into the video. The indicator is embedded (or added as an overlay) at a certain time instance corresponding to the predefined event in the video. In certain embodiments, the indicator can be a pixel of a predefined color that is added at a certain location in a frame of the video corresponding to the predefined event. In certain embodiments, the indicator can be a predefined shape that is embedded at the certain location in a frame of the video corresponding to the predefined event. In certain embodiments, the indicator can be a bar code or a quick response (QR) code. After the video is embedded with the indicator, the video is received and viewed by an end user.

In step 506, the server 200 receives a notification that the indicator was identified by a viewing device. In step 508, the server 200 transmits to the viewing device the obtained content for display. This enables the viewing device to display the content at a specific instance in response to the pixel appearing on the display of the viewing device.

The method 510 of FIG. 5B describes a viewing device displaying synchronizing content in response to identifying an indicator in the video steam. For example, if different users are viewing a video stream at different time instances, the synchronized content can be presented to the user based on a certain time or event occurrence in the video rather than all the viewers receiving the content at the same time instance.

In step 512, the electronic device 300 receives and displays a video. The video can be of a live event or a pre-recorded event. The video can be streamed. In step 514, the electronic device 300 while displaying the video identifies an indicator embedded at a certain point in the video. The indicator can be a certain pixel of a predefined color located at a certain location in a frame or series of frames.

In step 516, the electronic device 300 transmits a notification to a server that a certain indicator was included in the video. The notification, generated by the electronic device 300, can be sent to a particular server (such as the server 200 of FIG. 2 or the server 430 of FIG. 4A) specifying the various parameters of the indicator. The indicator parameters can include color, location in the frame, size, shape, and the like. By sending the parameters of the indicator to the server, enables the server to determine what information to transmit to the electronic device 300. For example, the server can include a look-up table within its memory (such as the memory 215 of FIG. 2) that relates certain information, that is to be transmitted as the synchronized content, to the specific parameters of the indicator. In other embodiments, the electronic device 300 may use the identified parameters of the indicator for the electronic device 300 determine which content to include in the video, without needing to send the parameters to the server for the determination. In another example, the indicator and/or the parameters of the indicator enable the electronic device 300 to know when to show content so that the additional content is synced with the displayed. For example, this additional content could be preloaded on client, awaiting execution, or the indicator may indicate when to request the additional content.

In step 518, the electronic device 300 can receive the content from the server. In step 520, the electronic device 300 displays the received content. In certain embodiments, the electronic device 300 displays the content over the video as an overlay. For example, the creator of the content may request viewers to vote or provide feedback on actions associated with the content (e.g., actions to take in a video game). As the content may not be consumed as the content is created (e.g., whether due to on demand viewing or small differences in time due to transmission and/or processing delays), the electronic device 300 is enabled to present the overlay at the appropriate time during the display of the content irrespective of when the content was created. In other examples, the overlay content may be supplemental content to personalize or improve the viewing experience for the viewer. For example, the supplemental content could be modifications to the appearance of objects or persons in the content or bonus content enabling certain viewers to have a different or improved viewing experience.

In other embodiments, the content may already be on the electronic device 300. For example, the electronic device 300 sees the indicator, the electronic device 300 can reacts and display the content without having to signal server to obtain the requested content. For example, the content could be preloaded on the client, and the electronic device 300 uses the indicator as a way to sync when to display the local content, for example, to reduce latency from having to request the content.

In certain embodiments, the indicator, that is identified in step 514, can be a coded symbol such as a bar code or a QR code. The electronic device 300 can scan (or read) the indicator and display the content as an overlay, as described above in step 520. In this embodiment, the steps 516 and 518 can be omitted. The electronic device 300, using the Internet (or any other network such as the network 101 of FIG. 1), can look up the content to be displayed based on the indicator. In other examples, the embedded indicator can be read and interpreted on the by the electronic device 300 and can immediately initiate the overlay display without having to communicate back to any server. For example, the electronic device 300 may identify a “start game” command via the embedded indicator, which the electronic device 300 would then interpret to make an overlay that is running locally on a browser of electronic device 300 to pop up a “game start” menu.

In other embodiments, step 516 may be performed and step 518 not. For example, electronic device 300 may perform the signaling at 516 sync with server streamed code, so signaling back to the server does let the server know when the content at the electronic device 300 was started. For example, in a video streaming scenario, this signaling may which a live streamer to know when members of their audience has completed the current event. For instance, if the streamer wanted to pick a winner from a drawing, the streamer would need to know when everyone has completed entering their name, for example, which means the streamer may need to wait for audience members to see the start and end portion of the event streamed on video before selecting a winner from the entrants.

FIGS. 6A, 6B, and 6C illustrate an electronic device 602 displaying content on a display 604. The electronic device 602 can be similar to any client devices 106-114 of FIG. 1, the electronic device 300 of FIG. 3, the electronic device 410, the electronic device 420, or the like). The display 604 can be similar to the display 355 of electronic device 300 of FIG. 3.

FIG. 6A illustrates the electronic device 602 at time T₀. FIG. 6B illustrates the electronic device 602 at time T₁. FIG. 6C illustrates the electronic device 602 at time T₂. It is noted that time T₀, T₁, and T₂ represent sequential time instances, where T₀<T₁<T₂

As illustrated in FIG. 6A, the electronic device 602 is displaying content on the display 604. This can be similar to the step 512 of FIG. 5B. FIG. 6B also illustrates the electronic device 602 is displaying content as well an indicator 606 on the display 604. The indicator 606 is included in the received content that is displayed. In certain embodiments, the indicator 606 is a QR code. FIG. 6C illustrates the electronic device 602 displaying the video content as well as the content 608. In certain embodiments, the content 608 can be an overlay that is displayed on top of the video content. For example, as discussed above, the overlay may be associated with a request for viewer feedback, such as voting or requesting certain actions be performed during a video game or other content. The size of the video content can also be adjusted such that the content 608 does not overlap any of the video content.

Although FIG. 5A illustrates the method 500, the FIG. 5B illustrates the method 510, and FIGS. 6A-6C illustrate various diagrams, various changes may be made to FIGS. 5A-6C. For example, while the method 500 and the method 510 are shown as a series of steps, various steps could overlap, occur in parallel, occur in a different order, or occur multiple times. In another example, steps may be omitted or replaced by other steps. For example, steps of the method 500 and the method 510 can be executed in a different order.

The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

In various embodiments, a method for content synchronization is provided. The method includes receiving, by an electronic device, video content for display on a display associated with the electronic device; identifying, by the electronic device, an indicator included in the video content; in response to identifying the indicator, identifying, by the electronic device, additional content to include with the video content displayed on the display; determining, by the electronic device, based on the video content, when to include the additional content with the video content; and providing, by the electronic device, the additional content for display on the display with the video content based on the determination.

In any of the above embodiments, wherein identifying the additional content to include with the video content further comprises: transmitting, by the electronic device, a notification of the identification of the indicator; and receiving, by the electronic device, information associated with the additional content to include with the video content.

In any of the above embodiments, identifying the additional content to include with the video content further comprises: identifying, by the electronic device, parameters of the indicator included in the video content; and identifying, by the electronic device, the additional content to include with the video content based on the parameters of the indicator.

In any of the above embodiments, determining when to include the additional content with the video content further comprises: identifying, based on when the indicator is displayed in the video content, a time in the video content displayed; and determining when to include the additional content for display on the display with the video content based on the identified time in the video content.

In any of the above embodiments, wherein determining when to include the additional content with the video content further comprises: identifying, based on when the indicator is displayed in the video content, an event occurring in the video content displayed; and determining when to include the additional content for display on the display with the video content based on the identified event occurring in the video content.

In any of the above embodiments, the method further comprises: receiving, by the electronic device, signals associated with an event; and transmitting, by the electronic device, a notification associated with detection of the signals associated with the event.

In any of the above embodiments, the method further comprises identifying, by the electronic device, receipt or modification of a digital good associated with a user of the electronic device as a result of the detection of the signals associated with the event.

Although the figures illustrate different examples of user equipment, various changes may be made to the figures. For example, the user equipment can include any number of each component in any suitable arrangement. In general, the figures do not limit the scope of this disclosure to any particular configuration(s). Moreover, while figures illustrate operational environments in which various user equipment features disclosed in this patent document can be used, these features can be used in any other suitable system. None of the description in this application should be read as implying that any particular element, step, or function is an essential element that must be included in the claims scope.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A method for content synchronization, the method comprising:
receiving, by an electronic device, video content for display on a display associated with the electronic device;
identifying, by the electronic device, an indicator included in the video content;
in response to identifying the indicator, identifying, by the electronic device, additional content to include with the video content displayed on the display;
determining, by the electronic device, based on the video content, when to include the additional content with the video content; and
providing, by the electronic device, the additional content for display on the display with the video content based on the determination.

2. The method of claim 1, wherein identifying the additional content to include with the video content further comprises:
transmitting, by the electronic device, a notification of the identification of the indicator; and
receiving, by the electronic device, information associated with the additional content to include with the video content.

3. The method of claim 1, wherein identifying the additional content to include with the video content further comprises:
identifying, by the electronic device, parameters of the indicator included in the video content; and
identifying, by the electronic device, the additional content to include with the video content based on the parameters of the indicator.

4. The method of claim 1, wherein determining when to include the additional content with the video content further comprises:
identifying, based on when the indicator is displayed in the video content, a time in the video content displayed; and
determining when to include the additional content for display on the display with the video content based on the identified time in the video content.

5. The method of claim 1, wherein determining when to include the additional content with the video content further comprises:
identifying, based on when the indicator is displayed in the video content, an event occurring in the video content displayed; and
determining when to include the additional content for display on the display with the video content based on the identified event occurring in the video content.

6. The method of claim 1, further comprising:
receiving, by the electronic device, signals associated with an event; and
transmitting, by the electronic device, a notification associated with detection of the signals associated with the event.

7. The method of claim 6, further comprising identifying, by the electronic device, receipt or modification of a digital good associated with a user of the electronic device as a result of the detection of the signals associated with the event.

8. An electronic device comprising:
a communication interface configured to receive video content for display on a display associated with the electronic device; and
a processor operably coupled with the communication interface, the processor configured to:
identify an indicator included in the video content;
in response to identification of the indicator, identify additional content to include with the video content displayed on the display;
determine, based on the video content, when to include the additional content with the video content; and
provide the additional content for display on the display with the video content based on the determination.

9. The electronic device of claim 8, wherein:
the communication interface is further configured to:
transmit a notification of the identification of the indicator; and
receive information associated with the additional content to include with the video content, and
the processor is further configured to identify the additional content to include with the video content based on the received information.

10. The electronic device of claim 8, wherein to identify the additional content to include with the video content, the processor is further configured to:
identify parameters of the indicator included in the video content; and
identify the additional content to include with the video content based on the parameters of the indicator.

11. The electronic device of claim 8, wherein to determine when to include the additional content with the video content, the processor is further configured to:
identify, based on when the indicator is displayed in the video content, a time in the video content displayed; and
determine when to include the additional content for display on the display with the video content based on the identified time in the video content.

12. The electronic device of claim 8, wherein to determine when to include the additional content with the video content, the processor is further configured to:
identify, based on when the indicator is displayed in the video content, an event occurring in the video content displayed; and
determine when to include the additional content for display on the display with the video content based on the identified event occurring in the video content.

13. The electronic device of claim 8, wherein the communication interface is further configured to:
receive signals associated with an event; and
transmit a notification associated with detection of the signals associated with the event.

14. The electronic device of claim 13, wherein the processor is further configured to identify receipt or modification of a digital good associated with a user of the electronic device as a result of the detection of the signals associated with the event.

15. A non-transitory, computer-readable medium comprising program code that, when executed by a processor of an electronic device, causes the electronic device to:
receive video content for display on a display associated with the electronic device;
identify an indicator included in the video content;
in response to identifying the indicator, identify additional content to include with the video content displayed on the display;
determine, based on the video content, when to include the additional content with the video content; and
provide the additional content for display on the display with the video content based on the determination.

16. The non-transitory, computer-readable medium of claim 15, wherein the program code that, when executed, causes the electronic device to identify the additional content to include with the video content further comprises program code that, when executed by the processor of the electronic device, causes the electronic device to:
transmit a notification of the identification of the indicator; and
receive information associated with the additional content to include with the video content.

17. The non-transitory, computer-readable medium of claim 15, wherein the program code that, when executed, causes the electronic device to identify the additional content to include with the video content further comprises program code that, when executed by the processor of the electronic device, causes the electronic device to:
identify, by the electronic device, parameters of the indicator included in the video content; and
identify, by the electronic device, the additional content to include with the video content based on the parameters of the indicator.

18. The non-transitory, computer-readable medium of claim 15, wherein the program code that, when executed, causes the electronic device to determine when to include the additional content with the video content further comprises program code that, when executed by the processor of the electronic device, causes the electronic device to:
identify, based on when the indicator is displayed in the video content, a time in the video content displayed; and
determine when to include the additional content for display on the display with the video content based on the identified time in the video content.

19. The non-transitory, computer-readable medium of claim 15, wherein the program code that, when executed, causes the electronic device to determine when to include the additional content with the video content further comprises program code that, when executed by the processor of the electronic device, causes the electronic device to:
identify, based on when the indicator is displayed in the video content, an event occurring in the video content displayed; and
determine when to include the additional content for display on the display with the video content based on the identified event occurring in the video content.

20. The non-transitory, computer-readable medium of claim 15, further comprising program code that, when executed by the processor of the electronic device, causes the electronic device to:
receive signals associated with an event;
transmit a notification associated with detection of the signals associated with the event; and
identify receipt or modification of a digital good associated with a user of the electronic device as a result of the detection of the signals associated with the event.
